(19) United States
(12) Patent Application Publication
(10) Pub. No.: US 2026/0145153 A1
(43) Pub. Date: May 28, 2026

(54) POLYMER PARTICLE PRODUCING APPARATUS

(71) Applicant: Panasonic Intellectual Property Management Co., Ltd., Osaka (JP)

(72) Inventors: JUNJI HOSOKAWA, Osaka (JP); TAICHI NAKAMURA, Osaka (JP); SHINNOSUKE AKIYAMA, Osaka (JP)

(21) Appl. No.: 19/393,657

(22) Filed: Nov. 19, 2025

(30) Foreign Application Priority Data
Nov. 28, 2024 (JP) 2024-207591

(51) Int. Cl. B01J 19/00; B01J 14/00; B01J 19/06

(52) U.S. Cl. CPC B01J 19/0093; B01J 14/00; B01J 19/06; B01J 2219/0086; B01J 2219/00889; B01J 2219/00894; B01J 2219/00984

(57) ABSTRACT

A polymer particle producing apparatus includes: a first flow path for feeding a first aqueous phase; a second flow path for feeding an emulsifier; a first mixer that mixes the first aqueous phase and the emulsifier to form a second aqueous phase; a third flow path for feeding the second aqueous phase mixed in the first mixer; a fourth flow path for feeding a monomer phase including a monomer; a second mixer that mixes the second aqueous phase and the monomer phase to form a third aqueous phase in which the monomer phase with the emulsifier adsorbed is dispersed, in which a flow path length of the third flow path is set to make a residence time of the second aqueous phase in the third flow path shorter than a time until the emulsifier reaches a dispersion unstable state in the second aqueous phase in the third flow path.

### BACKGROUND

### 1. Technical Field

The present disclosure relates to a polymer particle producing apparatus by emulsion polymerization.

### 2. Description of the Related Art

Polymer particles are widely used in the automobile industry, electronic devices, and the like. In particular, when an application as a coating material is assumed, it is required to efficiently synthesize polymer particles having a small average particle size and a uniform particle size distribution.

Emulsion polymerization is known as a technique for synthesizing polymer particles (refer to, for example, Patent Literature 1). In this method, fine polymer particles can be obtained by mixing a monomer as an oil phase with an emulsifier, dispersing the mixture in an aqueous phase, and performing a polymerization reaction of the monomer.

### CITATION LIST

### Patent Literature

PTL 1: Japanese Patent No. 6122698

### SUMMARY

The polymer particle producing apparatus according to the present disclosure includes: a first flow path for feeding a first aqueous phase; a second flow path for feeding an emulsifier; a first mixer that mixes the first aqueous phase and the emulsifier to form a second aqueous phase; a third flow path for feeding the second aqueous phase mixed in the first mixer; a fourth flow path for feeding a monomer phase including a monomer; a second mixer that mixes the second aqueous phase and the monomer phase to form a third aqueous phase in which the monomer phase with the emulsifier adsorbed to the monomer is dispersed, in which a flow path length of the third flow path is set to make a residence time shorter than a time until the emulsifier reaches a dispersion unstable state in the second aqueous phase in the third flow path.

### BRIEF DESCRIPTION OF THE DRAWINGS

FIG. 1 is a schematic view showing a configuration of a polymer particle producing apparatus according to a first exemplary embodiment;

FIG. 2 is a schematic view showing a configuration of a polymer particle producing apparatus according to Experimental Example 1;

FIG. 3 is a view showing Table 1 showing hydrophilic and hydrophobic values of emulsifiers, a flow path length of a third flow path, a residence time, and evaluation of polymer particles obtained in Experimental Examples 1 to 14.

### DETAILED DESCRIPTIONS

In the emulsion polymerization, an emulsifier previously prepared to any concentration with water or the like is used, and when the emulsifier is hydrophobic, dispersion of the emulsifier may become uneven after concentration adjustment, and it was difficult to obtain polymer particles having a desired particle size.

The present disclosure has been made in view of such problems, and an object of the present disclosure is to provide a polymer particle producing apparatus capable of stably preparing an emulsifier and reproducibly producing polymer particles having a desired particle size.

The polymer particle producing apparatus according to a first aspect includes: a first flow path for feeding a first aqueous phase; a second flow path for feeding an emulsifier; a first mixer that mixes a first aqueous phase and the emulsifier to form a second aqueous phase; a third flow path for feeding the second aqueous phase mixed in the first mixer; a fourth flow path for feeding a monomer phase including a monomer; a second mixer that mixes the second aqueous phase and the monomer phase to form a third aqueous phase in which the monomer phase with the emulsifier adsorbed to the monomer is dispersed, in which a flow path length of the third flow path is set to make a residence time of the second aqueous phase in the third flow path shorter than a time until the emulsifier reaches a dispersion unstable state in the second aqueous phase in the third flow path.

In the polymer particle producing apparatus according to a second aspect, in the first aspect, the flow path length of the third flow path may be in the range between 100 mm and 15000 mm.

In the polymer particle producing apparatus according to a third aspect, in the first aspect, the residence time of the second aqueous phase in the third flow path may be between 0.1 seconds and 25 seconds, inclusive.

In any one of the first to third aspects, the polymer particle producing apparatus according to the fourth aspect may further include a reaction tank in which the third aqueous phase is held and the monomer in the monomer phase with the emulsifier adsorbed is polymerized to fabricate polymer particles.

The polymer particle producing apparatus according to a fifth aspect may further include: a fifth flow path for feeding the third aqueous phase mixed in the second mixer to the reaction tank in the fourth aspect; and a sixth flow path for feeding a polymerization initiator for initiating polymerization of a monomer to the reaction tank.

In the polymer particle producing apparatus according to a sixth aspect, in any one of the first to fifth aspects, a flow path diameter of the third flow path between the first mixer and the second mixer may be between 0.1 mm and 10 mm.

In the polymer particle producing apparatus according to a seventh aspect, in any one of the first to sixth aspects, the emulsifier is a nonionic surfactant, and a hydrophile lipophile balance (HLB) of the emulsifier may be 13 or more.

In the polymer particle producing apparatus according to an eighth aspect, in any one of the first to sixth aspects, the emulsifier is an ionic surfactant, a solubility parameter (hereinafter, SP value) of the emulsifier may be 7 (cal/cm³)^{0.5} or more.

In the polymer particle producing apparatus according to a ninth aspect, in any one of the first to sixth aspects, the emulsifier is a nonionic surfactant, a hydrophile lipophile balance (HLB) of the emulsifier may be 15 or more.

In a polymer particle producing apparatus according to a tenth aspect, in any one of the first to sixth aspects, the emulsifier is an ionic surfactant, the SP value of the emulsifier may be 9 (cal/cm³)^{0.5} or more.

Hereinafter, a polymer particle producing apparatus according to an exemplary embodiment of the present disclosure will be described with reference to the accompanying drawings.

### First Exemplary Embodiment

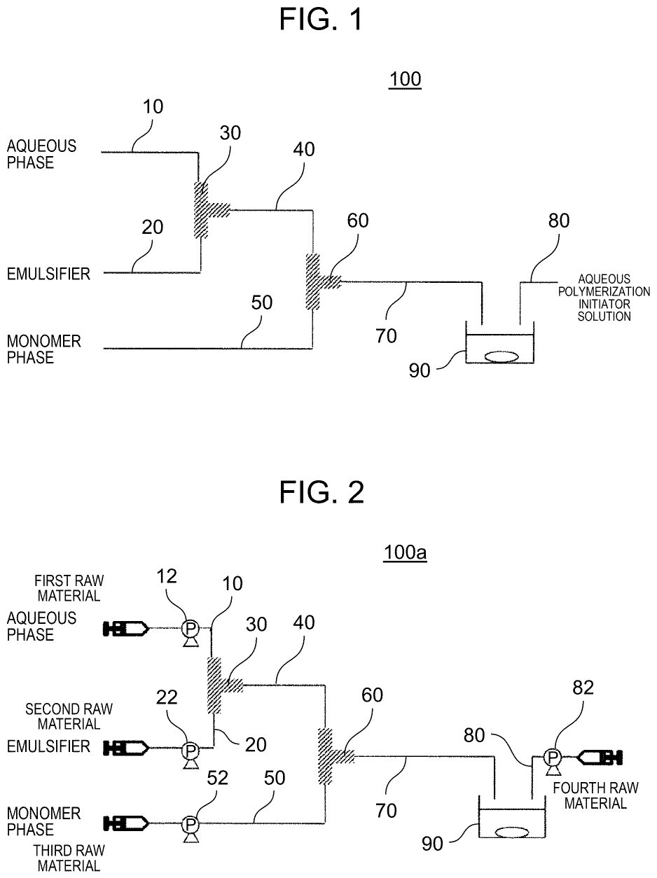

FIG. 1 is a schematic view showing a configuration of polymer particle producing apparatus 100 according to the first exemplary embodiment.

As shown in FIG. 1, polymer particle producing apparatus 100 according to the first exemplary embodiment includes: first flow path 10 that feeds a first aqueous phase; second flow path 20 for feeding an emulsifier; first mixer 30 that mixes the first aqueous phase and the emulsifier to form a second aqueous phase; third flow path 40 for feeding the second aqueous phase mixed in the first mixer 30; fourth flow path 50 for feeding a monomer phase including a monomer, in which second mixer 60 that mixes the second aqueous phase and the monomer phase to form a third aqueous phase in which the emulsifier is adsorbed and dispersed in the monomer. This polymer particle producing apparatus 100 is composed of a configuration in which a flow path length of third flow path 40 is set to make a residence time shorter than a time until the emulsifier reaches a dispersion unstable state in the second aqueous phase in third flow path 40.

As shown in FIG. 1, polymer particle producing apparatus 100 may further include reaction tank 90. In reaction tank 90, the third aqueous phase is held, and the monomer is polymerized in the monomer phase with the emulsifier adsorbed and dispersed to prepare polymer particles.

### <First Aqueous Phase>

The first aqueous phase is, for example, water. The water may be, for example, distilled water, pure water such as ion-exchanged water, or ultrapure water.

As shown in Experimental Example 1 of FIG. 2, the first aqueous phase may be held in, for example, a syringe. Alternatively, the first aqueous phase may be held in a water storage tank.

### <First Flow Path>

First flow path 10 for feeding the first aqueous phase has an inner diameter in a range from, for example, 0.01 mm to 5.00 mm inclusive. Further, the inner diameter may be in the range from 0.05 mm to 4.00 mm inclusive.

As shown in Experimental Example 1 of FIG. 2, for example, the first aqueous phase may be fed by a plunger pump.

### <Emulsifier>

The emulsifier may be any of an ionic surfactant, a nonionic surfactant, and a polymerizable emulsifier. When the emulsifier is an ionic surfactant, for example, the solubility parameter (hereinafter, SP value) is 7 (cal/cm³)^{0.5} or more. When the emulsifier is a nonionic surfactant, for example, a hydrophile lipophile balance (HLB) is 13 or more. The SP value was calculated from Fedors'estimation equation.

As the ionic surfactant, i.e., the anionic emulsifier, for example, sodium dodecylbenzene sulfonate, sodium lauryl sulfate, sodium alkyl diphenyl ether disulfonate, sodium polyoxyethylene alkyl ether sulfate, or the like can be used. As the cationic emulsifier, for example, stearylbenzyldimethylammonium chloride, distearylbenzyldimethylammonium chloride, or the like can be used.

As the nonionic surfactant, for example, polyoxyethylene alkyl ether, polyoxyethylene alkylphenyl ether, polyoxyalkylene polyol, polypropylene glycol ethylene oxide adduct, or the like can be used.

As the polymerizable emulsifier, for example, sodium alkylallyl sulfosuccinate, sodium (meth)acryloyl polyoxyalkylene sulfate, or the like can be used.

These may be used singly or in combination of two or more thereof.

As shown in Experimental Example 1 of FIG. 2, the emulsifier may be held in, for example, a syringe. Alternatively, the emulsifier may be held in a water storage tank.

### <Second Flow Path>

Second flow path 20 for feeding the emulsifier has an inner diameter in a range from, for example, 0.01 mm to 5.00 mm inclusive. Further, the inner diameter may be in the range from 0.05 mm to 4.00 mm inclusive.

As shown in Experimental Example 1 of FIG. 2, for example, the emulsifier may be fed by a plunger pump.

### <First Mixer>

First mixer 30 is provided at a junction of first flow path 10 and second flow path 20, and mixes the first aqueous phase and the emulsifier to form a second aqueous phase. First mixer 30 is not particularly limited, and examples thereof include a T-shaped mixer, a Y-shaped mixer, a V-shaped mixer, a plate mixer processed into any shape, and a double tube mixer. The inner diameter of the first mixer is, for example, in a range from 0.01 mm to 3.00 mm inclusive. Further, the inner diameter may be in a range from 0.05 mm to 2.50 mm inclusive.

### <Third Flow Path>

Third flow path 40 for feeding the second aqueous phase mixed in first mixer 30 has an inner diameter in a range from, for example, 0.01 mm to 5.00 mm inclusive. Further, the inner diameter may be in the range from 0.05 mm to 4.00 mm inclusive.

The flow path length of third flow path 40 is set to make a residence time shorter than a time until the emulsifier reaches in a dispersion unstable state in the second aqueous phase in third flow path 40. Specifically, the flow path length of third flow path 40 is, for example, in the range between 100 mm and 15000 mm. The residence time of the second aqueous phase in the third flow path is, for example, between 0.1 seconds and 25 seconds (inclusive). Setting the third flow path to the above-described flow path length and residence time allows the emulsifier to be mixed with the monomer phase in the second aqueous phase in a stable state in second mixer 60.

In the second aqueous phase in which the first aqueous phase and the emulsifier are mixed, the emulsifier is first dispersed in the aqueous phase, but in a state in which only the emulsifier is present, the emulsifier is in an unstable state with high energy, and the emulsifier dispersed with time aggregates and coalesces with each other, and the emulsifier and the aqueous phase are finally separated. In the intermediate stage, in the above case, for example, after 25 seconds, the dispersion becomes unstable, such as exhibiting non-uniform dispersion.

### <Monomer>

The monomer included in the monomer phase is not limited to the following, and because of an O/W emulsion type emulsion polymerization, the monomer is insoluble or hardly soluble in water, and may be, for example, a styrene-based monomer including derivatives such as styrene and methyl styrene, an acrylic acid derivative, an acrylamide derivative, a methacrylic acid derivative, a methacrylic acid ester, or a methacrylamide derivative. In addition, other monomers such as phenylene, thiophene, fluorene, alkyl, sulfone, ether, and fluoride can be used as long as the monomers are suitable for emulsion polymerization. These monomers may be used singly or in combination of two or more thereof.

As shown in Experimental Example 1 in FIG. 2, the monomer phase may be held in, for example, a syringe. Alternatively, the monomer phase may be held in a water storage tank.

### <Fourth Flow Path>

Fourth flow path 50 for feeding the monomer phase including the monomer has an inner diameter in a range from, for example, 0.01 mm and 5.00 mm inclusive. Further, the inner diameter may be in the range from 0.05 mm to 4.00 mm inclusive.

As shown in Experimental Example 1 in FIG. 2, for example, the monomer phase may be fed by a plunger pump.

### <Second Mixer>

Second mixer 60 is provided at a junction of third flow path 40 and fourth flow path 50, and mixes the second aqueous phase and the monomer phase to form a third aqueous phase in which the emulsifier is adsorbed and dispersed in the monomer.

### <Fifth Flow Path>

Fifth flow path 70 for feeding the third aqueous phase mixed in second mixer 60 to reaction tank 90 has an inner diameter in a range from, for example, 0.01 mm to 5.00 mm inclusive. Further, the inner diameter may be in the range from 0.05 mm to 4.00 mm inclusive.

### <Polymerization Initiator>

The polymerization initiator is not limited to the following, and water-soluble because of an O/W emulsion type emulsion polymerization, and for example, when a styrene-based monomer is used as a monomer, a peroxide such as ammonium persulfate, potassium persulfate, or sodium persulfate can be used. In addition, water-soluble organic peroxides, water-soluble azo compounds, redox-based initiators, persulfates, and the like can be used. These may be used singly or in combination of two or more thereof. The polymerization initiator may be supplied as, for example, an aqueous solution.

As shown in Experimental Example 1 of FIG. 2, the polymerization initiator may be held in, for example, a syringe. Alternatively, the polymerization initiator may be held in a water storage tank.

### <Sixth Flow Path>

Sixth flow path 80 for feeding the polymerization initiator for initiating polymerization of the monomer to the polymerization tank has an inner diameter in a range from, for example, 0.01 mm to 5.00 mm inclusive. Further, the inner diameter may be in the range from 0.05 mm to 4.00 mm inclusive.

As shown in Experimental Example 1 of FIG. 2, for example, the polymerization initiator may be fed by a plunger pump.

### <Reaction Tank>

Reaction tank 90 for holding the third aqueous phase may be provided. In reaction tank 90, the third aqueous phase is held, and the monomer phase in which the emulsifier is adsorbed and dispersed is polymerized to prepare polymer particles. Reaction tank 90 may be any tank as long as it can hold a predetermined amount of the third aqueous phase and produce polymer particles by emulsion polymerization. Reaction tank 90 may be appropriately stirred and mixed. In addition, temperature control may be performed.

Using reaction tank 90 having a predetermined capacity instead of the flow path makes it possible to solve the problem that a flow path having a long flow path length is required in the case of a long-time polymerization reaction. That is, reaction tank 90 can cope with a long-time polymerization reaction. For example, when the flow path length is 10,000 mm (10 m) and the residence time is 16 seconds, and the polymerization reaction time is 30 minutes, a flow path having a flow path length of 1,125,000 mm (1,125 m), i.e. more than 1 km is required in order to perform the polymerization reaction in the flow path. Further, when the polymerization reaction time is 2 hours, a flow path having a flow path length of 4.5 million mm (4,500 m: 4.5 km) is required to perform the polymerization reaction in the flow path. In contrast, in the case of reaction tank 90, reaction tank 90 having a capacity capable of holding the third aqueous phase may be prepared. Reaction tank 90 can be arbitrarily provided.

According to the polymer particle producing apparatus according to the first exemplary embodiment, polymer particles having a desired average particle size can be produced with high reproducibility.

### Experimental Example 1-14

Hereinafter, Experimental Example 1-14 in which polymer particles (polystyrene) were produced will be described.

### Experimental Example 1

FIG. 2 is a schematic view showing a configuration of polymer particle producing apparatus 100a according to Experimental Example 1.

In Experimental Example 1, each of raw material solutions for synthesizing a polymer is prepared as follows: ultrapure water as a first raw material; an aqueous emulsifier solution of 40 weight % of sodium sulfosuccinate (solubility parameter, hereinafter SP value, SP value=9 (cal/cm³)^{0.5}) that is an ionic surfactant as a second raw material; a monomer phase including a monomer (styrene monomer) as a third raw material; and an aqueous polymerization initiator solution prepared by adjusting ammonium persulfate as a fourth raw material so as to be 5.1 weight % in ultrapure water.

Two plunger pumps 12 and 22 were used as liquid feeders for the first raw material and the second raw material to feed two types of raw materials, respectively. Herein, the set flow rate of each of plunger pumps 12 and 22 was adjusted such that the flow rate of the mixed solution was 15 mL/min (flow rate of first raw material:flow rate of second raw material=5.3:1). In the case of the above flow rate, the emulsifier concentration after mixing of the two liquids is 6.4 weight %.

A T-shaped mixer (SUS316 material, inner diameter 0.25 mm) was used as mixer 30 (hereinafter, the first mixer) for the first raw material and the second raw material.

Plunger pump 52 was also used for the liquid feeder of the third raw material. The set flow rate of plunger pump 52 was adjusted such that the flow rate of the mixed solution was 30 mL/min (flow rate of mixture of first raw material and second raw material:flow rate of third raw material=1:1).

A T-shaped mixer (SUS316 material, inner diameter 0.25 mm) was also used for mixer 60 (hereinafter, the second mixer) of a mixture of the first raw material and the second raw material, and the third raw material. The flow path length of third flow path 40 from first mixer 30 to second mixer 60 was set to 100 mm. In this case, the residence time in the third flow path was 0.2 seconds.

The third aqueous phase that was the mixed liquid in the second mixer was recovered in reaction tank 90 (screw tube having a volume of 50 mL), and a stirring bar was set to 400 rpm using a hot stirrer and stirring was performed.

Plunger pump 82 was also used for the liquid feeder of the fourth raw material. The fourth raw material was fed at a flow rate of 1 mL/min and added to reaction tank 90 such that weight of fourth raw material: weight of third aqueous phase as mixed liquid in second mixer recovered in reaction tank 90=0.023:1. The aqueous polymerization initiator solution as the fourth raw material was added, and then a hot stirrer was set such that the liquid temperature of reaction tank 90 was 70° C., and stirring was performed for 2 hours to prepare polymer particles composed of polystyrene.

### Experimental Example 2

Polymer particles composed of polystyrene were synthesized in the same manner as in Experimental Example 1 except that sodium sulfosuccinate (SP value=7 (cal/cm³)^{0.5}) as an ionic surfactant was used as an emulsifier.

### Experimental Example 3

Polymer particles composed of polystyrene were synthesized in the same manner as in Experimental Example 1 except that polyoxyalkylene alkyl ether (HLB15) as a nonionic surfactant was used as an emulsifier.

### Experimental Example 4

Polymer particles composed of polystyrene were synthesized in the same manner as in Experimental Example 1 except that polyoxyalkylene alkyl ether (HLB13) as a nonionic surfactant was used as an emulsifier.

### Experimental Example 5

Polymer particles composed of polystyrene were synthesized in the same manner as in Experimental Example 1 except that the flow path length of the third flow path from the first mixer to the second mixer was set to 1,000 mm.

### Experimental Example 6

Polymer particles composed of polystyrene were synthesized in the same manner as in Experimental Example 1 except that the flow path length of the third flow path from the first mixer to the second mixer was set to 10,000 mm.

### Experimental Example 7

Polymer particles composed of polystyrene were synthesized in the same manner as in Experimental Example 1 except that the flow path length of the third flow path from the first mixer to the second mixer was set to 15,000 mm.

### Experimental Example 8

Polymer particles composed of polystyrene were synthesized in the same manner as in Experimental Example 1 except that sodium sulfate (SP value=8 (cal/cm³)^{0.5}) as an ionic surfactant was used as an emulsifier.

### Experimental Example 9

Polymer particles composed of polystyrene were synthesized in the same manner as in Experimental Example 1 except that the flow path length of the third flow path from the first mixer to the second mixer was set to 20,000 mm.

### Experimental Example 10

Polymer particles composed of polystyrene were synthesized in the same manner as in Experimental Example 2 except that the flow path length of the third flow path from the first mixer to the second mixer was set to 20,000 mm.

### Experimental Example 11

Polymer particles composed of polystyrene were synthesized in the same manner as in Experimental Example 3 except that the flow path length of the third flow path from the first mixer to the second mixer was set to 20,000 mm.

### Experimental Example 12

Polymer particles composed of polystyrene were synthesized in the same manner as in Experimental Example 4 except that the flow path length of the third flow path from the first mixer to the second mixer was set to 20,000 mm.

### Experimental Example 13

Polymer particles composed of polystyrene were synthesized in the same manner as in Experimental Example 1 except that sodium sulfosuccinate (SP value=5 (cal/cm³)^{0.5}) as an ionic surfactant was used as an emulsifier.

### Experimental Example 14

Polymer particles composed of polystyrene were synthesized in the same manner as in Experimental Example 1 except that polyoxyalkylene alkyl ether (HLB11) as a nonionic surfactant was used as an emulsifier.

### Evaluation

For the obtained polymer particles composed of polystyrene, the particle size distribution was measured, the standard deviation of the particle size and the average particle size were calculated, and the CV value (standard deviation÷average particle size) was calculated. As the CV value is smaller, the particle size distribution exhibits a narrower range at a center of the average particle size. In contrast, as the CV value is larger, the particle size distribution exhibits a wider distribution away from the average particle size. A case where the CV value was less than 20% was defined as A, a case where the CV value was 20% or more and less than 25% was defined as B, a case where the CV value was 25% or more and less than 30% was defined as C, and a case where the CV value was 30% or more was defined as D.

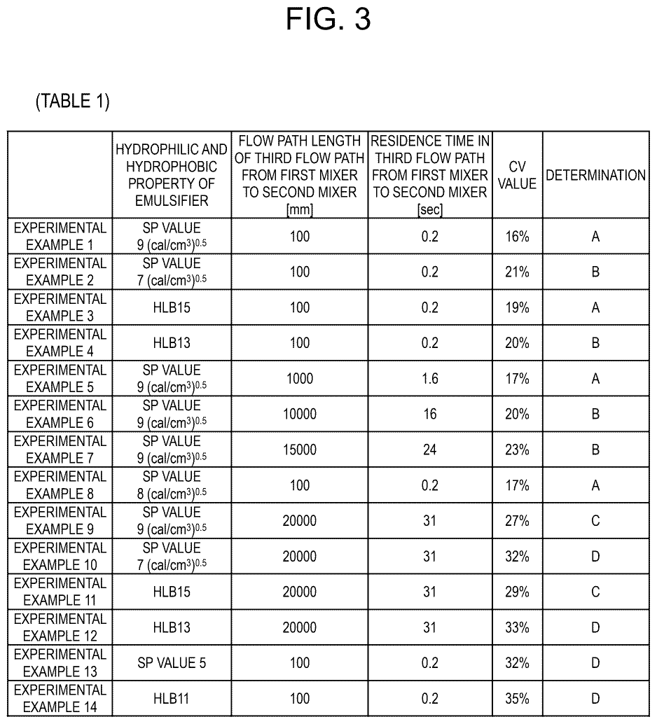

FIG. 3 is Table 1 showing the hydrophilic and hydrophobic value of the emulsifier, the flow path length of the third flow path, the residence time, and the evaluation of the obtained polymer particles in Experimental Examples 1 to 14.

As shown in FIG. 3, the CV value was 25% or less in Experimental Examples 1 to 8 in which the flow path length of the third flow path was in the range between 100 mm and 15,000 mm, the residence time of the second aqueous phase in the third flow path was between 0.1 seconds and 25 seconds (inclusive), the emulsifier was a nonionic surfactant, or the hydrophile lipophile balance (HLB) was 13 or more, the emulsifier was an ionic surfactant, and the solubility parameter (hereinafter SP value) was 7 (cal/cm³)^{0.5} or more.

When Experimental Examples 1, 5 to 7, and 9 are compared, the same emulsifier was used, the flow path length of the third flow path was changed to 100 mm, 1,000 mm, 10,000 mm, 15000 mm, and 20,000 mm, and the residence time was also changed to 0.2 seconds, 1.6 seconds, 16 seconds, 24 seconds, and 31 seconds, respectively. In this case, in Experimental Example 1 (flow path length: 100 mm, residence time: 0.2 seconds) and Experimental Example 5 (flow path length: 1000 mm, residence time: 1.6 seconds), the CV values are almost the same as 16% and 17%. However, as Experimental Example 6 (flow path length: 10,000 mm, residence time: 16 seconds), Experimental Example 7 (flow path length: 15000 mm, residence time: 24 seconds), and Experimental Example 9 (flow path length: 20,000 mm, residence time: 31 seconds), the CV value increases to 20%, 23%, and 27%, respectively, as the flow path length and the residence time become longer.

When Experimental Examples 2 and 10 are compared, the same emulsifier was used, the flow path length of the third flow path was changed to 100 mm and 20,000 mm, and the residence time was also changed to 0.2 seconds and 31 seconds, respectively. In this case, the CV value increases to 21% and 32% as the flow path length and the residence time become longer.

When Experimental Examples 1 and 2 and Experimental Example 13 are compared, the flow path length and the residence time of the third flow path were the same, and the solubility parameter SP value of the emulsifier was changed to 9 (cal/cm³)^{0.5}, 7 (cal/cm³)^{0.5}, and 5 (cal/cm³)^{0.5}. In this case, as the solubility parameter SP value decreases, the CV value increases to 16%, 21%, and 32%.

When Experimental Examples 3 and 4 and Experimental Example 14 are compared, the flow path length and the residence time of the third flow path are the same, and the HLB of the emulsifier is changed to 15, 13, and 11. In this case, as the HLB decreases, the CV value increases to 19%, 20%, and 35%, and in particular, rapidly increases with the HLB13 as a boundary.

According to the polymer particle producing apparatus according to the present disclosure, polymer particles having a desired average particle size can be produced with high reproducibility.

According to the polymer particle producing apparatus according to the present disclosure, the emulsifier can be mixed with the monomer phase in a stable state, and thus polymer particles having a desired average particle size can be produced with high reproducibility.

What is claimed is:

1. A polymer particle producing apparatus, comprising:
a first flow path for feeding a first aqueous phase;
a second flow path for feeding an emulsifier;
a first mixer that mixes the first aqueous phase and the emulsifier to form a second aqueous phase;
a third flow path for feeding the second aqueous phase mixed in the first mixer;
a fourth flow path for feeding a monomer phase including a monomer; and
a second mixer that mixes the second aqueous phase and the monomer phase to form a third aqueous phase in which the monomer phase with the emulsifier adsorbed to the monomer is dispersed,
wherein a flow path length of the third flow path is set to make a residence time of the second aqueous phase in the third flow path shorter than a time until the emulsifier reaches a dispersion unstable state in the second aqueous phase in the third flow path.

2. The polymer particle producing apparatus according to claim 1, wherein the flow path length of the third flow path is in a range between 100 mm and 15,000 mm.

3. The polymer particle producing apparatus according to claim 1, wherein the residence time of the second aqueous phase in the third flow path is between 0.1 seconds and 25 seconds, inclusive.

4. The polymer particle producing apparatus according to claim 1, further comprising a reaction tank in which the third aqueous phase is held and the monomer is polymerized in the monomer phase with the emulsifier adsorbed to the monomer to produce polymer particles.

5. The polymer particle producing apparatus according to claim 4, further comprising:
a fifth flow path for feeding the third aqueous phase mixed in the second mixer to the reaction tank; and
a sixth flow path for feeding a polymerization initiator for initiating polymerization of the monomer to the reaction tank.

6. The polymer particle producing apparatus according to claim 1, wherein a flow path diameter of the third flow path between the first mixer and the second mixer is between 0.1 mm and 10 mm.

7. The polymer particle producing apparatus according to claim 1, wherein the emulsifier is a nonionic surfactant, and a hydrophile lipophile balance (HLB) of the emulsifier is 13 or more.

8. The polymer particle producing apparatus according to claim 1, wherein the emulsifier is an ionic surfactant, and a solubility parameter (hereinafter, SP value) of the emulsifier is 7 (cal/cm³)^{0.5} or more.

9. The polymer particle producing apparatus according to claim 1, wherein the emulsifier is a nonionic surfactant, and a hydrophile lipophile balance (HLB) of the emulsifier is 15 or more.

10. The polymer particle producing apparatus according to claim 1, wherein the emulsifier is an ionic surfactant, and a SP value of the emulsifier is 9 (cal/cm³)^{0.5} or more.
